(19) United States
(12) Patent Application Publication
(10) Pub. No.: US 2005/0138723 A1
(43) Pub. Date: Jun. 30, 2005

(54) Spa and whirlpool device

(76) Inventors: Dudley G. Hind, Sunrise, FL (US); Irma E. Hind, Sunrise, FL (US)

Correspondence Address: David P. Lhota;Stearns Weaver Miller,et al., Suite 1900, 200 East Broward Boulevard, Fort Lauderdale, FL, 33301, US

(21) Appl. No.: 10/992,281

(22) Filed: Nov. 18, 2004

Related U.S. Application Data
(60) Provisional application No. 60/523,991, filed on Nov. 21, 2003.

(51) Int. Cl. A47K 3/02; A61H 33/04

(52) U.S. Cl. 4/538

(57) ABSTRACT

A spa and whirlpool conversion system for converting a standard bathtub into a spa or whirlpool wherein the system comprises an enclosure-casing having a standoff or spacing to allow piping, gasket, drain and pump inlet fittings, water jet nozzles, control box, on/off switch, ground fault interrupter and housing case for a pump and adjustable air inlet system. The invention may also include a pump and, or required plumbing lines to facilitate use of the invention. The bathtub enclosure or casing comprises a shell shaped to fit inside of an existing bathtub. The bathtub enclosure can be placed inside or over the bathtub cavity and rests on the gasket. The instant invention may also include plumbing lines and directionally adjustable water jet nozzles.

### CROSS REFERENCE TO RELATED APPLICATIONS

This application claims the benefit of provisional patent application Ser. No. 60/523,991 filed Nov. 21, 2003.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to an overlay for existing bathtubs, and more particularly, to an overlaid conversion kit to upgrade a standard bathtub into a self-contained spa and whirlpool bathtub system without demolition to the existing tub.

2. Description of the Background Art

Whirlpools and spas are popular in health clubs and at country clubs, but are often too expensive for the average person to purchase and install in their home. While the prior art discloses methods for converting a bathtub into a whirlpool, these methods require making cuts in and around the tub and can result in leaks and, or the demolition of the tub. If a device or system existed that could upgrade a standard bathtub into a self-contained spa and whirlpool bathtub system without demolition to the existing tub, it would be well received. The instant invention addresses this unfulfilled need in the prior art by providing an acrylic whirlpool and spa conversion kit and method for conveniently converting an existing bathtub into a complete permanently or temporarily installed whirlpool bath and spa with no demolition required.

### BRIEF SUMMARY OF THE INVENTION

In light of the foregoing, it is an object of the present invention to provide an overlaid conversion kit and system converts a standard bathtub into a self-contained spa or whirlpool.

It is another object of the instant invention to provide a system that converts a standard bathtub into a self-contained spa or whirlpool without cutting into the existing tub.

It is also an object of the instant invention to provide a self-contained spa or whirlpool system for use with an existing tub.

It is a further object of the instant invention to provide a self-contained spa or whirlpool system for use with an existing tub that uses existing water lines and faucets.

It is an additional object of the instant invention to provide a self-contained spa or whirlpool system for use with an existing tub that may be electronically controlled.

It is also an object of the instant invention to provide a self-contained spa or whirlpool system for use with an existing tub that is cost effective and adaptable for mass production.

The instant invention provides a whirlpool conversion kit or system that is designed to convert an existing standard bathtub into a whirlpool bath and, or spa. The whirlpool conversion kit, system and method of the instant invention comprises a plastic or acrylic bathtub enclosure-casing having a standoff or spacing to allow piping, gasket, drain and pump inlet fittings, water jet nozzles, control box, on/off switch, ground fault interrupter and housing case for a pump and adjustable air inlet system. The invention may also include a pump and, or required plumbing lines to facilitate use of the invention. The bathtub enclosure or casing comprises a shell shaped to fit inside of an existing bathtub. The bathtub enclosure can be placed inside or over the bathtub cavity and rests on the gasket, which preferably comprises a molded piece conforming to at least a portion of the tub. The instant invention may also include plumbing lines and directionally adjustable water jet nozzles.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of the preferred embodiment of the spa and whirlpool conversion kit in accordance with the instant invention.

FIG. 2 is a plan view of the preferred embodiment of the spa and whirlpool conversion kit in accordance with the instant invention.

FIG. 3 is a perspective view of the preferred embodiment of the ground fault interrupter, power switch and housing case for the pump and adjustable air inlet system of the spa and whirlpool conversion kit in accordance with the instant invention.

FIG. 4 is a perspective view of the preferred embodiment of the control box of the spa and whirlpool conversion kit in accordance with the instant invention.

FIG. 5 is an elevational view of the preferred embodiment of the spa and whirlpool conversion kit in accordance with the instant invention.

### DETAILED DESCRIPTION OF THE INVENTION

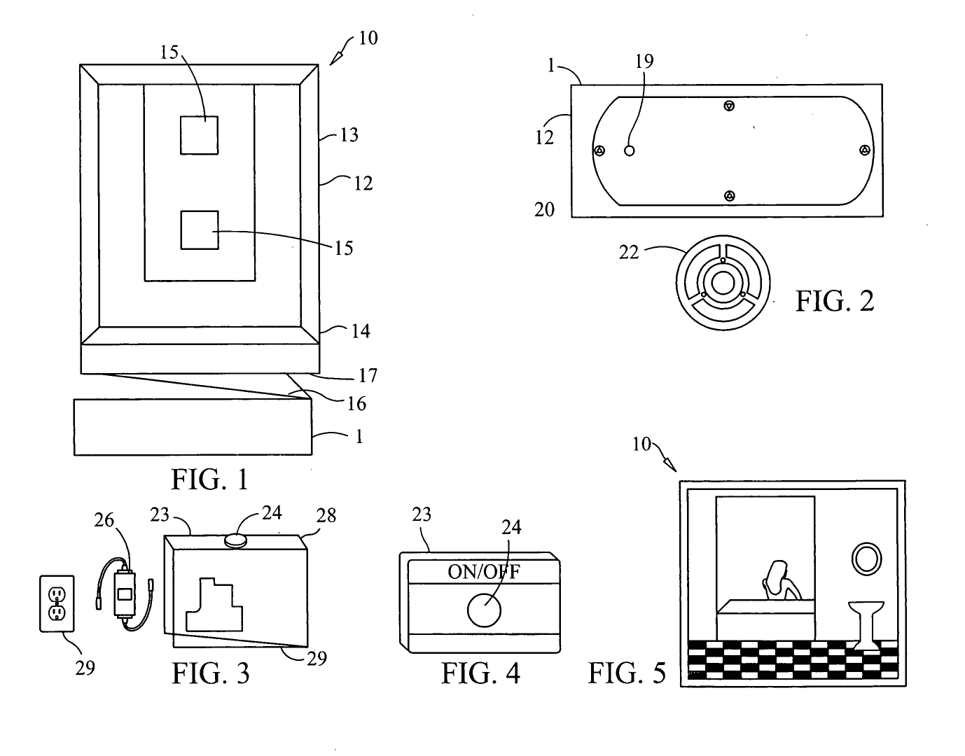

With reference to the drawings, FIGS. 1-5 depict the preferred embodiments of the instant invention which is generally referenced as a whirlpool conversion kit and, or system and, or by numeric character 10. With reference to FIGS. 1-5, the whirlpool conversion kit, system and method for converting an existing tub/shower into a spa/whirlpool 10 (individually and collectively referenced herein as whirlpool conversion kit 10) comprises a plastic or acrylic bathtub enclosure/casing 12, standoff/spacing 14 to allow piping, standoff gasket 16, drain and pump inlet 20, water jet nozzles 22, control box 23, on/off switch 24, ground fault interrupter 26 and housing case 28 for a pump and adjustable air inlet system. The invention 10 may also include a pump and, or required plumbing lines to facilitate use of the invention. The overlaid shell enclosure or casing 12 comprises walls 13 and bathtub basin 17 for holding water shaped to fit inside and, or over an existing bathtub 1 and rests on the standoff gasket 16. The enclosure 12 also includes at least one shelf or recession 15 for placing bath items, such as soap and shampoo, and a drain opening 19 that aligns with the bathtub drain when installed. The standoff gasket 16 is a molded-in-place bed of environmentally stable resilient adhesive foam, such as polyurethane. The conversion kit 10 includes plumbing for the passage of pressurized water. The plumbing may be molded into the shell enclosure 12 or placed within the standoff space or channel 14 defined between the enclosure 12 and bathtub 1. Alternatively, the channel passage(s) 14 may be molded into the shell enclosure 12. The conversion kit 10 may be fitted with directionally adjustable water jet nozzles 22 that may be pointed at various angles into the interior of the tub.

The whirlpool conversion kit 10 uses the tub's existing water lines and modern faucets to facilitate receipt of temperature adjustable water into the tub's cavity 1. The existing tub drain may be used or tapped either to drain water by gravity from the tub 1 or to shunt water from the tub 1 into the inlet of a water pump. An auxiliary port may also be used to drain water from the tub to the kit's water pump. An entrained air inlet valve 27 is located on or near the tub with the output of this valve connected to the inlet of the water pump 29. A pneumatically actuated switch 24 is placed in communication with the valve 27 to turn the whirlpool pump 29 on and off.

The enclosure 12 comprises upper molded plastic walls 13. The walls 13 of the shell enclosure 12 are applied over the existing bathroom walls adjacent to the tub, effectively hiding the walls to prevent water damage to the bathroom walls. The entire enclosure shell 12 is adhesively bonded to the bathroom walls and the bathtub 1.

The whirlpool conversion kit 10 is preferably equipped with a self-contained electric water pump 29, an air injector mechanism and an electrically isolated on/off switch 24. The whirlpool conversion kit 10 is also fitted with an electrical code compliant grounding current sensor and disconnect. Electrical power may be provided through a permanently wired connection or power cord connected to a wall-mounted receptacle 29. These components may all be contained within an external housing 23 adjacent to the tub.

The invention 10 is designed for installation over existing bathtubs however the whirlpool conversion kit 10 may be installed over a supporting frame if the existing bathtub is not of the proper shape, size or orientation for proper installation. The whirlpool conversion kit 10 is installed with a minimum of demolition of the existing bathroom in a short period of time. The whirlpool conversion kit 10 may be manufactured in various lengths, widths and heights. The whirlpool conversion kit 10 may be made in a variety of colors or designs to cater to specific markets. In an alternative embodiment, an auxiliary water heater may be incorporated in the pump enclosure 23 for installations not fitted with hot water access.

The shell enclosure 12 may be manufactured from acrylic plastic or epoxy bonded glass fibers. The faucets, drain and associated valves may be made from steel, stainless steel, plastic or brass or other code compliant materials. The pressurized water pipes may be made from molded acrylic plastic or epoxy bonded glass fibers, polyvinyl chloride (PVC) tubing or pipe or metallic pipe or tubing. The gasket 16 comprises an adhesive bonding foam cushion that is also used to define and provide a standoff distance or channel for running the associated water lines. The gasket 16 is preferably made from polyurethane or other environmentally stable foam material.

With reference to FIG. 3, the invention's water pump housing 23 is preferably made with a dimensionally stable thermoplastic, fiberglass reinforced epoxy, brass or stainless steel incorporating a corrosion resistant impeller and water resistant seals. A conventional copper wound remotely controlled electric motor is preferably used to power the pump 29. The actuation of the electric motor is preferably a pneumatic or hydraulic mechanism but may alternatively comprise an electrically isolated and independent switch 24. The mechanical switching of the electrical current may be done if the system is non-conductive and does not pose an electrical hazard for the operator.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

1. A conversion system for converting a standard bathtub into a whirlpool or spa, said system comprising:
a shell enclosure comprising at least one wall and bathtub basin, said shell enclosure being adapted for at least partially fitting in and over the standard bathtub, said basin including at least one drainage port positioned for aligning the standard bathtub's drain and a plurality of water jet apertures;
a standoff gasket for positioning between said shell enclosure and the standard bathtub, said gasket being molded to at least partially fit in the standard bathtub;
conduit means for tapping into existing water lines;
channel means for at least partially concealing and storing said conduit means;
water jettison means for ejecting pressurized water into said basin; and
control means for controlling the output of said water jettison means.

2. A system as recited in claim 1, wherein said shell enclosure comprises acrylic.

3. A system as recited in claim 1, wherein said shell enclosure comprises plastic.

4. A system as recited in claim 1, wherein said gasket comprises a polyurethane foam.

5. A system as recited in claim 1, further comprising:
a pump means for facilitating the ejection of water into said basin.

6. A system as recited in claim 1, wherein said channel means is defined by the space between said gasket and said shell enclosure.

7. A system as recited in claim 1, wherein said channel means is defined by said shell enclosure.

8. A system as recited in claim 1, wherein said channel means is defined by said gasket.

9. A system as recited in claim 1, wherein said system further comprises at least one adjustable water jet nozzle supported by said shell enclosure.

10. A system as recited in claim 5, wherein said system further comprises means for directing a water supply to said pump means.

11. A system as recited in claim 1, wherein said control means comprises an entrained air inlet valve.

12. A system as recited in claim 1, wherein said control means comprises a pneumatically actuated switch.

13. A system as recited in claim 1, wherein said system further comprises an adjustable air inlet system.

14. A system as recited in claim 1, wherein said system further comprises;
a pump;
a motor for energizing said pump; and
a housing for storing said pump and said motor.

15. A system as recited in claim 1, wherein said control means comprises an electronic control panel and ground fault interrupter.
